(19) United States
(12) Patent Application Publication
(10) Pub. No.: US 2025/0313707 A1
(43) Pub. Date: Oct. 9, 2025

(54) POWDER PAINT COMPRISING A RE-DISPERSIBLE DISPERSION POWDER

(71) Applicant: BASF SE, Ludwigshafen am Rhein (DE)

(72) Inventors: Christian SCHMIDTKE, Lemfoerde (DE); Torben GAEDT, Traunstein (DE); Roland BAUMSTARK, Ludwigshafen am Rhein (DE); Jochen GATTERMAYER, Ludwigshafen am Rhein (DE); Martin WINKLBAUER, Trostberg (DE)

(21) Appl. No.: 18/872,863

(22) PCT Filed: Jun. 9, 2023
(86) PCT No.: PCT/EP2023/065448

§ 371 Date: Dec. 9, 2024

(30) Foreign Application Priority Data
Jun. 10, 2022 (EP) 22178388.9

(51) Int. Cl. C09D 7/65; C09D 7/43; C09D 7/61; C09D 7/80; C09D 125/14

(52) U.S. Cl. CPC C09D 7/65; C09D 7/43; C09D 7/61; C09D 7/80; C09D 125/14

(57) ABSTRACT

The present invention is directed to the use of specific pyrrolidone-based (co)polymer as spray-drying additive (also known as spray drying aid; SDA) in a powder paint comprising at least one re-dispersible dispersion powder (RDP). The present invention is further directed to a powder paint comprising an RDP comprising at least one (co)polymer selected from the group consisting of acrylic acid ester polymer and acrylic-styrene copolymer and at least one pyrrolidone-based (co)polymer, as well as a process of manufacturing a paint.

The present invention is directed to the use of specific pyrrolidone-based (co)polymer as spray-drying additive (also known as spray drying aid; SDA) in a powder paint comprising at least one re-dispersible dispersion powder (RDP). The present invention is further directed to a powder paint comprising an RDP comprising at least one (co)polymer selected from the group consisting of acrylic acid ester polymer and acrylic-styrene copolymer and at least one pyrrolidone-based (co)polymer, as well as a process of manufacturing a paint.

Powder paints have the advantage that the transportation is connected with a reduced carbon dioxide emission since the total weight is reduced. Further, powder paints provide a long stability since they do not comprise a liquid medium.

An appropriate method for converting an aqueous dispersion to a re-dispersible dispersion powder (RDP) is spray drying. This involves spraying and dewatering the aqueous dispersion in a hot air stream. In order to assure spray drying of the dispersion and re-dispersibility of the dispersion powder, a spray-drying additive (SDA) is generally added to the aqueous dispersion. During the spray-drying process, it is assumed that the SDA forms a protective shell around the dispersion particles, which protects the particles from filming during the spray drying.

Formaldehyde condensation products can be used as SDA, such as melamine-formaldehyde (DE 2049114 A1), phenol sulfonic acid-formaldehyde (WO 98/03576 A1), and naphthalene sulfonic acid-formaldehyde condensation products (WO 98/03577 A1). However, these SDAs described in the prior art have disadvantages. For example, they discolor the dispersion powder, they show coloration effects (yellow-brown discoloration) under UV light, and formaldehyde emission during fabrication and/or in the application system.

Hence, there is an ongoing need to provide suitable spray drying aid for the manufacturing of powder paints as well as for powder paints comprising the same.

Against this background, it is an object of the present invention to provide a suitable spray drying aid for the manufacturing of powder paints. In this connection, it is an object of the present invention to provide an SDA having less discoloration. Further, it is an object of the present invention to provide an SDA having reduced formaldehyde emission during fabrication and/or in the application system (e.g. in the powder paint). Further, it is an objection of the present invention to provide an environmentally friendly SDA. It is further an object of the present invention to provide a re-dispersible dispersion powder having a suitable re-dispersibility. It is an additional object of the present invention to provide a stable powder paint. In this connection, it is an object of the present invention to provide a powder paint having a reduced discoloration and/or a reduced formaldehyde emission. Further, it is an object of the present invention to provide a durable paint.

It has surprisingly been found that at least one of these objects can be achieved by using a pyrrolidone-based (co)polymer as SDA in a powder paint comprising at least one re-dispersible dispersion powder (RDP) as claimed. It has further been found that the powder paints as defined hereinafter provide improved wet scrub resistance as well as a suitable re-dispersibility.

In a first aspect, the present invention therefore relates to a pyrrolidone-based (co)polymer for use or the use of a pyrrolidone-based (co)polymer as spray drying aid in a method of manufacturing a powder paint comprising at least one re-dispersible dispersion powder (RDP) comprising
i) a (co)polymer selected from the group consisting of acrylic acid ester polymer, acrylic-styrene copolymer, styrene-butadiene-based copolymer, and mixtures thereof and
ii) said pyrrolidone-based (co)polymer.

In the following, preferred embodiments of the components of the RDP are described in further detail. It is to be understood that each preferred embodiment is relevant on its own as well as in combination with other preferred embodiments.

In a preferred embodiment A1 of the first aspect, the pyrrolidone-based (co)polymer is a homo N-vinylpyrrolidone or a copolymerisate of N-vinylpyrrolidone and vinyl acetate.

In a preferred embodiment A2 of the first aspect, the at least one pyrrolidone-based (co)polymer is a pyrrolidone-containing polymer (PP) comprising at least one unit of the general formulae (I) to (Ill)

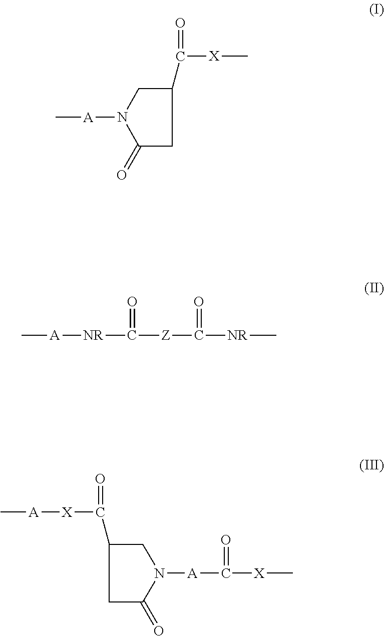

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

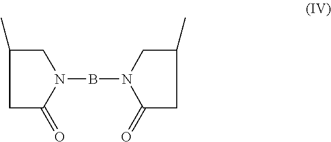

in which B is C₁-C₂₀-alkanediyl, which optionally is interrupted by one or more non-adjacent oxygen atoms, sulfur atoms or functional groups —NR— where the nitrogen atom is optionally protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A.

In a second aspect, the present invention relates to a powder paint comprising
a) 5 to 30 wt.-% of at least one pigment;
b) 10 to 25 wt.-% of at least one re-dispersible dispersion powder (RDP) comprising
i) at least one (co)polymer selected from the group consisting of acrylic acid ester polymer and acrylic-styrene copolymer and
ii) at least one pyrrolidone-based (co)polymer;
c) 40 to 78 wt.-% of at least one filler;
d) 0 to 2 wt.-% of at least one dispersing agent;
d) 0 to 2 wt.-% of at least one thickener; and
e) 0 to 2 wt.-% of at least one defoamer,
each based on the total dry weight of the powder paint, wherein the pyrrolidone-based (co)polymer is a pyrrolidone-containing polymer (PP) comprising at least one unit of the general formulae (I) to (Ill)

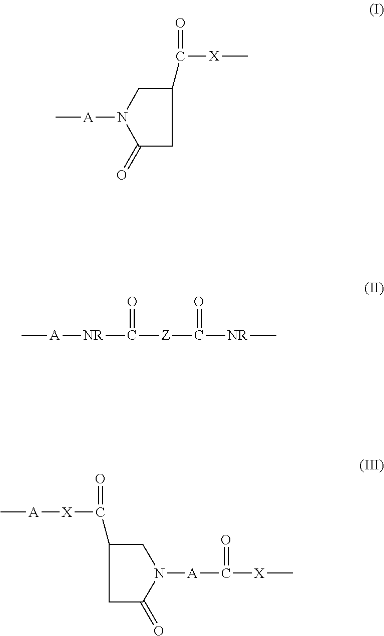

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂O-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—, wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₆-C₁₀ alkyl, C₃-C₁₀ cycloalkyl and C₂-C₁₅ alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

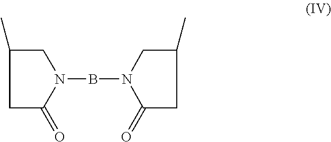

in which B is C₁-C₂₀-alkanediyl, which optionally is interrupted by one or more non-adjacent oxygen atoms, sulfur atoms or functional groups —NR— where the nitrogen atom is optionally protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A.

In a third aspect, the present invention relates to a process of manufacturing a paint, the process comprising mixing the powder paint according to the second aspect with water, preferably wherein a solid content of 45 to 70 wt.-%, more preferably of 50 to 65 wt.-%, based on the total weight of the paint is adjusted.

### DETAILED DESCRIPTION

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±10%, preferably ±5%, more preferably ±2%, and in particular ±1%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

The term “substituted”, as used herein, means that a hydrogen atom bonded to a designated atom is replaced with a specified substituent, provided that the substitution results in a stable or chemically feasible compound. Unless otherwise indicated, a substituted atom may have one or more substituents and each substituent is independently selected.

When neither the term “unsubstituted” nor “substituted” is explicitly mentioned concerning a moiety, said moiety is to be considered as unsubstituted.

The term “alkyl” as used herein denotes in each case a straight-chain or branched alkyl group having usually from 1 to 10 carbon atoms, preferably 1 to 5 or 1 to 4 carbon atoms, or 1 to 3 or 1 or 2 carbon atoms. Examples of an alkyl group are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-di-methylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethyl-butyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, and 1-ethyl-2-methylpropyl.

The term “alkanediyl” as used herein denotes in each case a hydrocarbon having e.g. 2 to 20 carbon atoms and two free valences. It is therefore a biradical having e.g. 2 to 20 carbon atoms.

The term “alkanediyl” encompasses both linear and branched, and also saturated and unsaturated, hydrocarbons having e.g. 2 to 20 carbon atoms and two free valences. Saturated hydrocarbons are preferred. Examples of C2-C20-alkanediyls are ethylene (ethane-1,2-diyl, dimethylene), propane-1,3-diyl (trimethylene), propylene (propane-1,2-diyl), and butane-1,4-diyl (tetramethylene). The alkanediyl group bridges a certain group to the remainder of the molecule.

The term “cycloalkanediyl” as used herein denotes in each case a cyclic hydrocarbon having e.g. 3 to 20 carbon atoms and two free valences. It is therefore a biradical having e.g. 3 to 20 carbon atoms. The term “cycloalkanediyl” encompasses both cyclic hydrocarbons and hydrocarbons having a cyclic fraction and a linear fraction having e.g. 3 to 20 carbon atoms and two free valences. Examples of C3-C20-cycloalkanediyls are cyclopropanediyl, cyclobutanediyl, cyclopentanediyl, cyclohexanediyl, cycloheptanediyl, cyclooctanediyl and cyclodecanediyl.

The term “arylene” as used herein denotes in each case a linking aromatic cyclic moiety having usually 6 to 20 carbon atoms, e.g. 6, 7, 8, 10 or 12, carbon atoms. The arylene group bridges a certain group to the remainder of the molecule. The arylene group can e.g. be phenylene. In this connection it is to be understood that aromatic means that the Hückel (4n+2) rule is fulfilled.

The term “cycloalkyl” as used herein denotes in each case a cyclic hydrocarbon radical with a carbon atom number from e.g. 3 to 10. The term “cycloalkyl” also encompasses hydrocarbons having a cyclic fraction and a linear fraction having e.g. 3 to 10 carbon atoms and one free valence. Examples of such cycloalkyl radicals are cyclopropyl, cyclobutyl, cyclopentyl, cyclohexyl, cycloheptyl, cyclooctyl and cyclodecyl.

The term “alkenyl” as used herein denotes in each case an unsaturated hydrocarbon group having usually 2 to 15, preferably 2 to 10 carbon atoms comprising at least one carbon-carbon double bond in any position, e.g. vinyl (ethenyl), allyl (2-propen-1-yl), 1-propen-1-yl, 2-propen-2-yl, methallyl (2-methylprop-2-en-1-yl), 2-buten-1-yl, 3-buten-1-yl, 2-penten-1-yl, 3-penten-1-yl, 4-penten-1-yl, 1-methylbut-2-en-1-yl, 2-ethylprop-2-en-1-yl, pentenyl, hexenyl and the like. If geometric isomers are possible with regard to the double bond, the present invention relates to both, the E- and Z-isomers. Preferred alkenyl groups according to the invention are terminal alkenyl groups. The bonding of vinyl is exemplified below:

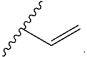 [SMILES: *C=C]

The organic moieties mentioned in the above definitions of the variables are collective terms for individual listings of the individual group members. The prefix Cₙ-Cₘ indicates in each case the possible number of carbon atoms in the group.

“At least one itaconic acid derivative” within the context of the present invention means precisely one itaconic acid derivative and also a mixture of two or more itaconic acid derivatives. The same hold for terms such as “at least one diamine”, “at least one amino acid”, “at least one (inorganic/organic) pigment”, “at least one re-dispersible dispersion powder”, “at least one (co)polymer”, “at least one pyrrolidone-based (co)polymer”, “at least one filler”, “at least one dispersing agent”, “at least one thickener”, “at least one defoamer”, and the like.

The terms “component (A)” and “at least one itaconic acid derivative” are used synonymously in the context of the present invention and, therefore, possess the same meaning.

The same holds true for the terms “component (B)” and “at least one amino acid”. These terms are used synonymously in the context of the present invention, as well, and, therefore, possess the same meaning.

When referring to compositions and the weight percent of the therein comprised ingredients it is to be understood that according to the present invention the overall amount of ingredients does not exceed 100% (±1% due to rounding).

The term “particle” or “polymer particle” as used herein refers to a polymeric fragment having a specific particle size Dx with regard to a specific particle size distribution, wherein x % of the particles have a diameter that is less than the Dx-value. The D₅₀ particle size is the median of the particle size distribution. The particle size distribution may e.g. be determined via dynamic light scattering (e.g. according to ISO 22412:2008). The particle size distribution may be indicated as volume distribution, surface distribution, or number distribution. Preferably, the Dx-value is the number distribution, wherein x % of the total number of the particles have a smaller diameter.

Preferred embodiment regarding the use of the SDA, of the powder paint and of the method of manufacturing a paint are described hereinafter. It is to be understood that the preferred embodiments of the invention disclosed herein are intended to be encompassed individually as well as in combination with each other. All possible combinations of preferred embodiments thus also form part of the present invention.

As indicated above, the present invention relates in one embodiment to a pyrrolidone-based (co)polymer for use as spray drying aid or the use of a pyrrolidone-based (co)polymer as spray drying aid in a method of manufacturing a powder paint comprising at least one re-dispersible dispersion powder (RDP) comprising
i) a (co)polymer selected from the group consisting of acrylic acid ester polymer, acrylic-styrene copolymer, styrene-butadiene-based copolymer, and mixtures thereof and
ii) said pyrrolidone-based (co)polymer.

In the following, preferred embodiments of the use, which are relevant for all aspects of the invention, are described in further detail. It is to be understood that each preferred embodiment is to be encompassed individually as well as in combination with other preferred embodiments.

In a preferred embodiment, the pyrrolidone-based (co)polymer is a homo N-vinylpyrrolidone or a copolymerisate of N-vinylpyrrolidone and vinyl acetate.

The homo N-vinylpyrrolidone and the copolymerisate of N-vinylpyrrolidone and vinyl acetate may suitably have a weight average molecular weight (Mw; determined by gel permeation chromatography (GPC) with 0.05 M aqueous ammonium formate/methanol mixture=80:20 (parts by volume) as eluent) of 5 to 2000 kDa, preferably of 6 to 1500 kDa. Further suitable weight average molecular weight (Mw; determined as given above) ranges of the homo N-vinylpyrrolidone and the copolymerisate of N-vinylpyrrolidone and vinyl acetate are 6 to 12 kDa or 20 to 120 kDa or 1000 to 2000 kDa, preferably 7 to 11 kDa or 30 to 100 kDa or 1100 to 1800 kDa, and in particular 8 to 10 kDa or 40 to 70 kDa or 1300 to 1600 kDa.

The homo N-vinylpyrrolidone and the copolymerisate of N-vinylpyrrolidone and vinyl acetate may have a number average molecular weight (Mn; determined by gel permeation chromatography (GPC) as given above for Mw) of 0.5 to 500 kDa, preferably of 1 to 350 kDa. Further suitable number average molecular weight ranges of the homo N-vinylpyrrolidone and the copolymerisate of N-vinylpyrrolidone and vinyl acetate are 0.5 to 5 kDa or 9 to 20 kDa or 280 to 400 kDa, preferably 1 to 4 kDa or 10 to 18 kDa or 290 to 280 kDa, and in particular 1 to 3 kDa or 12 to 16 kDa or 310 to 340 kDa.

In this connection, the determination of the molecular weight (weight average molecular weight (Mw) and number average molecular weight (Mn)) of the polymers was generally performed as outlined in the experimental section in more detail.

Commercially available homo N-vinylpyrrolidones suitable for use according to the present invention include, without limitation, Luvitec® K 17, Luvitec® K 30, Luvitec® K 90, and PVP10.

Commercially available suitable copolymerisates of N-vinylpyrrolidone and vinyl acetate include, without limitation, Luvitec® VA 64.

In a preferred embodiment, the at least one pyrrolidone-based (co)polymer is a pyrrolidone-containing polymer (PP).

“Pyrrolidone-containing polymer (PP)”, as used in the context of the present invention, means that the polymer comprises pyrrolidonyl groups, typically as part of the polymer backbone. Pyrrolidonyl groups are known to the skilled person. Pyrrolidonyl groups are radicals are derived from pyrrolidone having at least one carbon radical, i.e. are derived from pyrrolidone by removing one hydrogen atom from one of the ring atoms. Bivalent radical groups are explicitly covered by said term. The polymer may be a pyrrolidone-containing copolymer. In various embodiments, the term as used herein thus excludes polymers in which the pyrrolidone group is a pendant group, such as PVP. In various embodiments the polymer of the invention is thus not PVP. Pyrrolidonyl groups as part of the backbone may mean that they are bivalent repeating units of the polymer's backbone structure.

The pyrrolidone-containing polymers (PP) of the invention are advantageous over known PVP polymers in that they are more readily biodegradable and may be produced from renewable raw materials, such as itaconic acid and amino acids, in particular lysine. Further, they are easily soluble in water and aqueous solutions with high polymer concentrations are easily obtainable. A still further advantage is that the polymers of the invention can be synthesized as melts or solids and it is not necessary to carry out the reaction in solution. It has further been found that the claimed pyrrolidone-containing polymers (PP) are less sticky, less hygroscopic and more stable upon storage than common PVP polymers.

“Spray drying aid”, as used herein, relates to compounds that protect another compound or composition that is spray-dried from adverse effects that may occur upon drying and the exposure to elevated temperatures and pressures that are typical for commercial spray-drying processes. Such adverse effects include but are not limited to irreversible agglomeration and/or filming of the spray-dried compound or composition that impair its subsequent use and/or application, such as the re-dispersion in a liquid medium. Spray-drying aids achieve this by forming a protective shell or matrix that coats or embeds the spray-dried compound/composition during the spray-drying process. Spray-drying aids are thus functionally different from compounds used for solubilization or as protective colloids, as the latter are used for improving the solubility or dispersibility in liquid, typically aqueous media, while the former need to withstand the conditions during spray-drying and be able to protect other compounds from adverse effects of the spray-drying, for example by forming a protective shell around them or a protective matrix in which they are embedded. It is important to note that a spray-drying aid thus function in a different way than solubilizers or protective colloids that are commonly unsuited to prevent formation of irreversible, insoluble and/or non-dispersible aggregates upon drying. In order to avoid that the polymers used as spray-drying aids are incorporated into the polymers of the aqueous polymer dispersion to be spray-dried, which may impair their functionality, they are typically not present during the generation of the polymer to be spray-dried but are added to the product polymer or a composition that contains said product polymer, such as the aqueous polymer dispersion referred to herein.

In a preferred embodiment, the at least one pyrrolidone-based (co)polymer is a pyrrolidone-containing polymer (PP) comprising at least one unit of the general formulae (I) to (Ill)

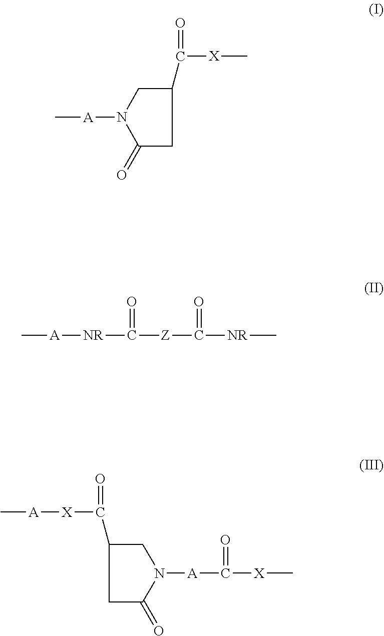

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₆-C₁₀ alkyl, C₃-C₁₀ cycloalkyl and C₂-C₁₅ alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

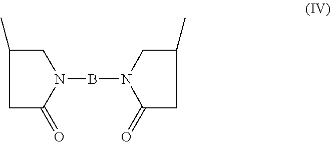

in which B is C₁-C₂₀-alkanediyl, which optionally is interrupted by one or more non-adjacent oxygen atoms, sulfur atoms or functional groups —NR— where the nitrogen atom is optionally protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A.

In a preferred embodiment, the pyrrolidone-containing polymer (PP) comprises at least one unit of the general formulae (I) to (II)

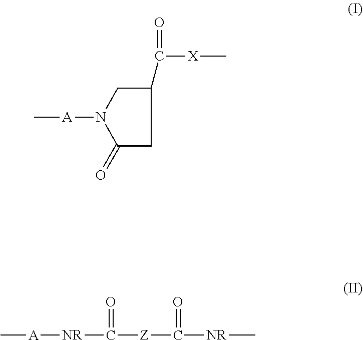

wherein R is independently hydrogen or C₁-C₂-alkyl;
X is —NR;
A is independently selected from the group consisting of C₁-C₂₀-alkanediyl, which optionally carries at least one functional group selected from the group consisting of C(═O)R² and SO₃H,
wherein
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl;
Z is a group of formula (IV)

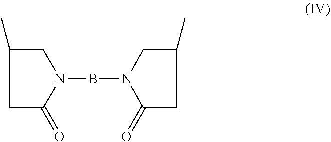

in which B is C₁-C₂₀-alkylene, which optionally carries additional functional groups —COOH or —SO₃H, or a mixture of the group of formula (IV) with groups A.

Preferably, A is C₁-C₂₀-alkanediyl, more preferably C₁-C₁₅-alkanediyl, and in particular C₁₋₁₀-alkanediyl. In some embodiments, A is C₁-, C₂-, C₃-, C₄-, C₅- or C₆-alkanediyl, preferably C₅ alkanediyl. The alkanediyl may preferably be linear and saturated. In various embodiments, it preferably carries one functional C(═O)R² group, optionally on the terminal carbon atom, e.g. the C₁ carbon atom. In such embodiments, the R² group is preferably OR³, with R³ preferably being H.

Preferably, B is C₁-C₁₅-alkanediyl, more preferably C₁-C₁₀-alkanediyl, and in particular C₁₋₈-alkanediyl. In some embodiments, B is C₁-, C₂-, C₃-, C₄-, C₅- or C₆-alkanediyl, preferably C₆-alkanediyl. The alkanediyl may preferably be linear and saturated. In various embodiments, it preferably carries one functional —COOH group, optionally on the terminal carbon atom, e.g. the C₁ carbon atom.

In various embodiments, the pyrrolidone-containing polymer (PP) is obtainable by polymerization of a reactive mixture (rM1), wherein the reactive mixture (rM1) comprises at least the following components:
(A) at least one itaconic acid derivative, preferably wherein component (A) is selected from the group consisting of itaconic acid, itaconic anhydride, itaconic esters and itaconyl halides, and
(B) at least one diamine, preferably wherein the diamine is selected from the group consisting of ethylenediamine, 1,3-diaminopropane, 1,4-diaminobutane, 1,5-pentanediamine, 1,6-diaminohexane, 1,7-diaminoheptane, 1,8-diaminooctane, and 1,9-diaminononane, more preferably ethylenediamine and 1,5-pentanediamine.

In a preferred embodiment, the reactive mixture (rM1) comprises at least two diamines, preferably selected from the group consisting of ethylenediamine, 1,3-diaminopropane, 1,4-diaminobutane, 1,5-pentanediamine, 1,6-diaminohexane, and 1,7-diaminoheptane, and in particular wherein the reactive mixture (rM1) comprises ethylenediamine and 1,5-pentanediamine.

Preferably, the reactive mixture (rM1) comprises component (A) and the at least one diamine, preferably sum of the at least two diamines, in a molar ratio of 10:1 to 1:10, preferably of 5:1 to 1:5, and in particular of 4:1 to 1:2 or 3:1 to 1:5.

In a preferred embodiment, component (A) and the at least one diamine, preferably the sum of the at least two diamines, are present in the reactive mixture (rM1) in a molar ratio of 3:1 to 1:3, preferably of 2:1 to 1:2, and in particular of 1.5:1 to 1:1.5

In a preferred embodiment, the reactive mixture (rM1) comprises in the range from 35 to 99 wt.-%, preferably from 40 to 90 wt.-%, more preferably from 50 to 75 wt.-%, of component (A) and in the range of 1 to 65 wt.-%, preferably from 10 to 60 wt.-%, more preferably from 25 to 50 wt.-%, of the at least one diamine, based on the sum of the percentages by weight of components (A) and the at least one diamine, preferably based on the total weight of the reactive mixture (rM1).

Unless otherwise indicated all of the percentages by weight of components (A) and the at least one amine as well as of optionally comprised solvent (S), such as water, are based on the total weight of the composition of the reactive mixture (rM1) before the start of the polymerization of the reactive mixture (rM1).

In various embodiments, the pyrrolidone-containing polymer (PP) preferably has a weight average molecular weight (Mw; determined by gel permeation chromatography (GPC) with 0.05 M aqueous ammonium formate/methanol mixture=80:20 (parts by volume) as eluent) of 500 to 100,000 g/mol, more preferably of 1,000 to 10,000 g/mol, still more preferably of 2,000 to 8,000 g/mol, and in particular of 3,000 to 6,000 g/mol. Preferably, the pyrrolidone-containing polymer (PP) has a number average molecular weight (Mn; determined by gel permeation chromatography (GPC) with 0.05 M aqueous ammonium formate/methanol mixture=80:20 (parts by volume) as eluent) of 500 to 20,000 g/mol, more preferably of 800 to 10,000 g/mol, still more preferably of 1,000 to 8,000 g/mol, and in particular of 1,000 to 4,000 g/mol. Preferably, the pyrrolidone-containing polymer (PP) has a K-value (determined according to H. Fikentscher, Cellulose-Chemie 13, pages 48-64 und pages 71-94 (1932)) of 5 to 35, more preferably of 10 to 30, still more preferably of 14 to 25, and in particular of 15 to 22.

In a preferred embodiment, the reactive mixture (rM1) comprises water. The water comprising reaction mixture (rM1) is stirred and heated under reflux, preferably for 0.2 to 5 hours, more preferably for 0.5 to 3 hours, and in particular for 0.5 to 2 hours. After heating, the water is preferably removed via distillation/evaporation. The distillation can be performed under normal pressure and/or by applying a vacuum.

In a preferred embodiment, the pyrrolidone-containing polymer (PP) is obtainable by polymerization of a reactive mixture (rM2), wherein the reactive mixture (rM2) comprises at least the following components:
(A) at least one itaconic acid derivative, preferably wherein component (A) is selected from the group consisting of itaconic acid, itaconic anhydride, itaconic esters and itaconyl halides, and
(B) at least one amino acid of the general formula (1)

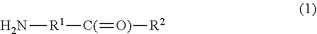

wherein
R¹ is selected from the group consisting of at least monosubstituted C₂-C₂₀-alkanediyl and at least monosubstituted C₃-C₂₀-cycloalkanediyl, wherein the substituent is NH₂;
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl.

Preferably,
R¹ is selected from the group consisting of at least monosubstituted C₂-C₂₀-alkanediyl, wherein the substituent is NH₂,
R² is selected from the group consisting of OH and Cl.

Particularly preferably,
R¹ is selected from the group consisting of precisely monosubstituted C₃-C₁₀-alkanediyl, wherein the substituent is NH₂, for example linear and saturated C₄-, C₅-, or C₆-, preferably C₅-alkanediyl,
R² is OH.

In a preferred embodiment, component (B) is selected from the group consisting of L-Lysine, D-Lysine and racemic mixtures of L-Lysine and D-Lysine. It is particularly preferred that component (B) is L-Lysine.

In a preferred embodiment, the reactive mixture (rM2) comprises in the range of from 0.5 to 70 wt.-%, preferably from 5 to 70 wt.-%, more preferably from 10 to 60 wt.-%, and in particular from 20 to 50 wt.-%, component (A) and in the range of from 30 to 99.5 wt.-%, preferably from 30 to 95 wt.-%, more preferably from 40 to 90 wt.-%, and in particular from 50 to 80 wt.-%, of the at least one component (B), based on the sum of the percentages by weight of components (A) and the at least one component (B), preferably based on the total weight of the reactive mixture (rM2).

In a preferred embodiment, the at least one itaconic acid derivative and the at least one amino acid of the general formula (1) are present in the reactive mixture (rM2) in a molar ratio of 10:1 to 1:10, preferably of 6:1 to 1:5 or of 5:1 to 1:5, and in particular of 4:1 to 1:2 or 3:1 to 1:5 or of 3:1 to 1:2.

Preferred is a pyrrolidone-containing polymer (PP) wherein the molar ratio of component (A) to component (B) in the reactive mixture (rM2) is in the range from 3:1 to 1:2 or from 3:1 to 1:10.

In this connection, the pyrrolidone-containing polymer (PP) preferably has a weight average molecular weight (Mw; determined by gel permeation chromatography (GPC) with 0.05 M aqueous ammonium formate/methanol mixture=80:20 (parts by volume) as eluent) of 500 to 100,000 g/mol, more preferably of 1,000 to 5,0000 g/mol, still more preferably of 1,000 to 10,000 g/mol, and in particular of 1,500 to 8,000 g/mol. Preferably, the pyrrolidone-containing polymer (PP) has a number average molecular weight (Mn; determined by gel permeation chromatography (GPC) with 0.05 M aqueous ammonium formate/methanol mixture=80:20 (parts by volume) as eluent) of 500 to 20,000 g/mol, more preferably of 500 to 10,000 g/mol, still more preferably of 500 to 8,000 g/mol, and in particular of 1,000 to 6,000 g/mol. Preferably, the polydispersity (PD) of the pyrrolidone-containing polymer (PP) is typically in the range from 1.1 to 5, preferably in the range 1.1 to 4 and most preferably in the range from 1.1 to 3. The polydispersity (PD) is the ratio between the weight average molar weight (Mw) and the number average molecular weight (Mn) of the pyrrolidone-containing polymer (PP). Preferably, the pyrrolidone-containing polymer (PP) has an amino number of 20 to 500 mg KOH/g, more preferably of 50 to 450 KOH/g, and in particular of 150 to 400 KOH/g, determined by titration. Suitable titration methods are known to the skilled person and exemplarily described in further detail in the examples of the invention.

Unless otherwise indicated all wt.-% values of components (A) and (B) as well as of an optionally comprised component (C) are based on the total weight of the composition of the reactive mixture (rM2) before the start of the polymerization of the reactive mixture (rM2).

The phrase “composition of the reactive mixture (rM2) before the start of the polymerization” refers in the context of the present invention to the composition of the reactive mixture (rM2) before components (A) and (B) as well as optional component (C) present in the reactive mixture (rM2) begin to react with one another, in other words, before the polymerization sets in. The components (A) and (B) as well as optional component (C) present in the reactive mixture (rM2) are at that point therefore still in their unreacted form. It is self-evident that during the polymerization of components (A) and (B) as well as optional component (C) the components react at least partially with one another with the result that the proportion of the components to each other changes just as the components present in the reactive mixture (rM2) change during the polymerization. The skilled person is aware of these reactions.

As described above for the wt.-%, the molar ratio also relates to the molar ratio of component (A) to component (B) before the beginning of the polymerization, and, therefore, before components (A) and (B) have reacted with one another.

The reactive mixture (rM2) may further comprise at least one catalyst as a component (C).

“At least one catalyst”, as used in the context of the present invention, means exactly one catalyst or a mixture of two or more catalysts.

The terms “component (C)” and “at least one catalyst” are used synonymously in the context of the present invention and, therefore, possess the same meaning.

Suitable components (C) are catalysts which catalyze the reaction between components (A) and (B). Examples of suitable catalysts are phosphoric acid, alkali metal dihydrogen phosphates, alkali metal hypophosphites, alkali metal hydrogen sulfates, tin octanoates, titanium(IV)butoxide and bismuth-2,2-diphenylundecanoate.

Therefore, the reactive mixture (rM2) preferably additionally comprises as component (C) at least one catalyst selected from the group consisting of phosphoric acid, alkali metal dihydrogen phosphates, alkali metal hypophosphites, alkali metal hydrogen sulfates, tin octanoates, titanium(IV)butoxide and bismuth-2,2-diphenylundecanoate.

Titanium(IV)butoxide is also referred to as Ti(OBu)4.

Alkali metal hypophosphites are preferred as component (C). Suitable alkali metal hypophosphites are known to the skilled person and are for example selected from the group consisting of lithium hypophosphite, sodium hypophosphite and potassium hypophosphite. Sodium hypophosphite is particularly preferred as component (C).

For example, the reactive mixture (rM2) comprises in the range of from 0.1 to 5 wt.-% of component (C), preferably in the range of from 0.1 to 3 wt.-% and particularly preferably in the range of from 0.1 to 2 wt.-%, based on the sum of the percentages by weight of components (A), (B) and (C), preferably based on the total weight of the reactive mixture (rM2).

To the person skilled in the art it is readily apparent that the percentages by weight (wt.-%) of components (A) and (B) as well as optional component (C) usually add up to 100% by weight.

The polymerization of the reactive mixture (rM2) may be carried out in the presence of at least one solvent (S).

“At least one solvent (S)”, as used in the context of the present invention, includes exactly one solvent (S) and mixtures of two or more solvents (S).

Suitable solvents (S) are known to the skilled person and are preferably solvents (S) which are inert towards the components comprised in the reactive mixture (rM2). Preferably, the at least one solvent (S) is selected from the group consisting of water, DMSO (dimethyl sulfoxide), NMP (N-methyl-2-pyrrolidone), butyl acetate, methyl ethyl ketone and mixtures thereof. Preferably, the at least one solvent (S) is water.

For example, the polymerization of the reactive mixture (rM2) is carried out at temperatures in the range from 50 to 300° C., preferably in the range from 70 to 250° C. and particularly preferably in the range from 90 to 240° C.

The polymerization can be carried out as a one step process or as a multi-step process. These processes are known to the person skilled in the art and are described in more detail below with respect to the process for producing the pyrrolidone-containing polymer (PP).

During the polymerization, components (A) and (B) undergo a polycondensation reaction to form the pyrrolidone-containing polymer (PP).

In a preferred embodiment, the pyrrolidone-containing polymer (PP) is biodegradable. Preferably, the pyrrolidone-containing polymer (PP) has a biodegradability (determined according to OECD301F) of more than 20%, more preferably of more than 30%, still more preferably of more than 40%, and in particular of more than 45%, after 28 days. It is also preferred that the pyrrolidone-containing polymer (PP) has a biodegradability (determined according to OECD301F) of 20 to 100%, more preferably of 30 to 99%, still more preferably of 40 to 99% or of 40 to 90%, after 28 days.

Preferably the pyrrolidone-containing polymer (PP) comprises at least one unit of the general formula (A)

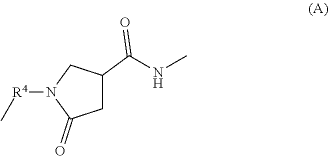

wherein
R⁴ is selected from the group consisting of at least monosubstituted C₂-C₂₀-alkanediyl and C₃-C₂₀-cycloalkanediyl, wherein at least one substituent is C(═O)R², wherein
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl.
R⁴ is preferably selected from the group consisting of at least monosubstituted C₂-C₂₀-alkanediyl, wherein at least one substituent is C(═O)R², wherein
R² is selected from the group consisting of OH and Cl.
R⁴ is most preferably selected from the group consisting of monosubstituted C₃-C₁₀-alkanediyl, wherein the substituent is C(═O)OH.

In a preferred embodiment, the powder paint comprises at least one inorganic pigment and/or at least one organic pigment.

Preferably, the powder paint comprises an inorganic pigment, more preferably selected from the group consisting of titanium dioxide, preferably in the rutile form, barium sulfate, zinc oxide, zinc sulfide, basic lead carbonate, antimony trioxide, lithopone (zinc sulfide and barium sulfate), iron oxides, carbon black, graphite, zinc yellow, zinc green, ultramarine, manganese black, antimony black, manganese violet, Prussian blue and Parisian green, in particular titanium dioxide.

Preferably, the powder paint comprises an organic pigment, more preferably wherein the organic pigment is in the form of hollow organic particles and/or is based on polymers, comprising nonionic ethylenically unsaturated monomers, preferably wherein the nonionic ethylenically unsaturated monomer is selected from the group consisting of styrene, acrylonitrile, methacrylamide, methyl methacrylate, ethyl acrylate, ethyl methacrylate, butyl acrylate, butyl methacrylate, 2-ethylhexyl acrylate, 2-ethylhexyl methacrylate, or mixtures thereof.

The (co)polymer is preferably made up of ethylenically unsaturated compounds (units/monomers) in polymerized form. In this connection it is to be understood that the (co)polymer is preferably provided as a polymer dispersion, more preferably as an aqueous polymer dispersion. The preparation of these polyaddition compounds is generally carried out by metal complex-catalyzed, anionically catalyzed, cationically catalyzed and particularly preferably free-radically catalyzed polymerization, as is familiar to a person skilled in the art, of ethylenically unsaturated compounds.

The free-radically catalyzed polymerization of ethylenically unsaturated compounds will be familiar to a person skilled in the art and is, in particular, carried out by the method of free-radical bulk, emulsion, solution, precipitation, or suspension polymerization, with free-radically initiated aqueous emulsion polymerization being particularly preferred.

Carrying out free-radically initiated emulsion polymerization of ethylenically unsaturated compounds (monomers) in an aqueous medium is known [cf. Emulsion polymerization in Encyclopedia of Polymer Science and Engineering, Vol. 8, pages 659 ff. (1987); D. C. Blackley, in High Polymer Latices, Vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422 and Dispersionen synthetischer Hochpolymerer, F. Hölscher, Springer-Verlag, Berlin (1969)]. Free-radically initiated aqueous emulsion polymerization is usually carried out by dispersing the monomers, generally with concomitant use of dispersants such as emulsifiers and/or protective colloids, in an aqueous medium and polymerizing them by means of at least one water-soluble free-radical polymerization initiator. Frequently, the residual contents of unreacted monomers in the aqueous polymer dispersions obtained are decreased by chemical and/or physical after-treatment, the polymer solids content is set to a desired value by dilution or concentration or further customary additives, for example foam- or viscosity-modifying additives, are added to the aqueous polymer dispersion.

Possible monomers are, in particular, monomers which can be free-radically polymerized in a simple manner, for example ethylene, vinylaromatic monomers such as styrene, α-methylstyrene, or o-chlorostyrene, vinyl acetate, acrylic acid, esters of acrylic acid and methacrylic acid with alkanols, which generally have from 1 to 12, preferably from 1 to 8 and in particular from 1 to 4, carbon atoms, especially methyl, ethyl, n-butyl, isobutyl, pentyl, hexyl, heptyl, octyl, nonyl, decyl (e.g. hydroxyethyl methacrylate), esters of acrylic acid and methacrylic acid with alkanes, which generally have from 1 to 12, preferably from 1 to 10, and in particular from 1 to 8, carbon atoms (e.g. ethyl acrylate, butyl acrylate, 2-ethylhexyl acrylate, 2-propylheptyl acrylate), and 1,3-butadiene. When preparing a polymer dispersion, the monomers mentioned generally form the main monomers which, based on the amount of all ethylenically unsaturated compounds used for preparing the polymer dispersion (total amount of monomers), add up to a proportion of ≥50% by weight, preferably ≥80% by weight and particularly preferably ≥90% by weight. In general, these monomers have only a moderate to low solubility in water under standard conditions [20° C., 1 atm (=1.013 bar absolute)].

In a preferred embodiment, the (co)polymer is an acrylic-styrene copolymer.

Suitably, the acrylic-styrene copolymer is obtainable by free-radical polymerization of styrene and/or methylstyrene, in particular styrene, with acrylates selected from the group consisting of methyl acrylate, ethyl acrylate, butyl acrylate, 2-ethylhexyl acrylate, hydroxyethylmethacrylate, 2-propylheptyl acrylate, and mixtures thereof, in particular selected from the group consisting of 2-ethylhexyl acrylate, hydroxyethylmethacrylate, butyl acrylate, and mixtures thereof. In this connection, it is to be understood that methylstyrene generally refers to alpha-methylstyrene, beta-methylstyrene, 2-methylstyrene, 3-methylstyrene, and 4-methylstyrene, preferably to alpha-methylstyrene.

Preferably, the acrylic-styrene copolymer is obtainable by free-radical polymerization of 15 to 50 wt.-%, more preferably 20 to 45 wt.-%, and in particular 25 to 40 wt.-%, of styrene and/or methylstyrene with 50 to 85 wt.-%, more preferably 55 to 80 wt.-%, and in particular 60 to 75 wt.-%, of at least one acrylate. In this connection it is preferred that styrene is polymerized with the at least one acrylate selected from the group consisting of methyl acrylate, ethyl acrylate, butyl acrylate, 2-ethylhexyl acrylate, hydroxyethylmethacrylate, 2-propylheptyl acrylate, and mixtures thereof, in particular selected from the group consisting of 2-ethylhexyl acrylate, hydroxyethylmethacrylate, butyl acrylate, and mixtures thereof.

In a preferred embodiment, the polymer dispersion comprises a styrene-butadiene-based copolymer.

In a preferred embodiment, the polymer dispersion, preferably the aqueous polymer dispersion, has a solid polymer content, determined according to DIN EN ISO 3251, from 20 to 70 wt.-%, more preferably from 25 to 72 wt.-%, even more preferably from 30 to 65 wt.-%, and in particular from 50 to 62 wt.-%, and in particular of 52 to 62 wt.-%, based on the total weight of the aqueous polymer dispersion.

In a preferred embodiment, the (co)polymer, preferably the acrylic-styrene copolymer, has a Tg (glass transition temperature), calculated using the Fox equation, of −60 to 20° C., preferably of −50 to 10° C., more preferably of −40 to 20° C., and in particular of −30 to 10° C. or of −25 to 0° C. or of −5 to 20° C. According to Fox (cf. T. G. Fox, Bull. Am. Phys. Soc. (Ser II) 1, 123, [1956] and Ullmanns Enzyklopädie der technischen Chemie, Weinheim (1980), S. 17, 18) the following equation is a suitable approximation for the Tg of polymer dispersions:

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

wherein X¹, ^{X}2, . . . , Xⁿ are the mass fractions 1, 2, . . . , n and Tg¹, Tg², . . . , Tgⁿ are the glass transition temperatures, in kelvins, of homopolymers of each of the monomers 1, 2, . . . , n. The individual Tgs are known, for example, from Ullmann's Encyclopedia of Industrial Chemistry, VCH, Weinheim, Vol. A 21 (1992) p. 169 and from J. Brandrup, E. H. Immergut, Polymer Handbook 3^{rd} ed., J. Wiley, New York 1989.

In a preferred embodiment, the (co)polymer, preferably the acrylic-styrene copolymer, has an average particle size (D 50 value) of the polymer particles as measured by dynamic light scattering (e.g. determined according to ISO 22412:2008) of 50 to 1000 nm, preferably of 100 to 900 nm, more preferably of 150 to 750 nm.

The aqueous polymer dispersion may additionally comprise at least one surface active compound. The surface active compound serves to stabilize the aqueous dispersion of the polymer by keeping the particles of the polymer dispersed. The surface active compound may be an emulsifier, a protective colloid or a mixture of both of them. The emulsifier and the protective colloid differ from each other by their weight-average molar mass Mw. An emulsifier typically has a weight average molar mass Mw below 2000, while the weight-average molar mass Mw of a protective colloid may be up to 50 000, in particular from above 2000 to up to 50000. Typically, the amount of the surface active compound is in the range of from 0.1 to 10% by weight, in particular in the range of from 0.5 to 5% by weight, based on the total amount of polymer in the aqueous polymer dispersion.

Preferably, the surface active compound comprises one or more emulsifiers. The emulsifier may be non-ionic, anionic, or cationic. In case of employing a mixture of emulsifiers, their compatibility has to be ensured, which can in case of doubt be evaluated by preliminary tests. Typically, an anionic emulsifier is compatible with another anionic emulsifier or a non-ionic emulsifier. Similarly, a cationic emulsifier is typically compatible with another cationic emulsifier or a non-ionic emulsifier. Preferably, the emulsifier is an anionic emulsifier, a combination of two or more anionic emulsifier or a combination of at least one anionic emulsifier and at least one non-ionic emulsifier. Non-ionic emulsifiers include, for example, ethoxylated C₈-C₃₆ fatty alcohols having a degree of ethoxylation of from 3 to 50 (=ethylene oxide units [EO]: 3-50) and ethoxylated mono-, di- and tri-C₄-C₁₂ alkylphenols having a degree of ethoxylation of from 3 to 50. Examples of customary nonionic emulsifiers are the Eumulgin B grades (cetyl/stearyl alcohol ethoxylates, RTM BASF), Dehydol LS grades (fatty alcohol ethoxylates, EO units: 1-10, RTM BASF), Lutensol A grades (C₁₂C₁₄-fatty alcohol ethoxylates, EO units: 3-8, RTM BASF), Lutensol AO grades (C₁₃C₁₅-oxo alcohol ethoxylates, EO units: 3-30), Lutensol AT grades (C₁₆C₁₈-fatty alcohol ethoxylates, EO units: 11-80), Lutensol ON grades (C10-oxo alcohol ethoxylates, EO units: 3-11) and Lutensol TO grades (C₁₃-oxo alcohol ethoxylates, EO units: 3-20). Here and in the following, the phrase “EO units” means the average number of ethylene oxide repeating units in the emulsifier. Anionic emulsifiers include for example the alkali metal salts of dialkyl esters of sulfosuccinic acid, the alkali metal salts and the ammonium salt of C₈-C₁₂ alkyl sulfates, the alkali metal salts and the ammonium salts of C₁₂-C₁₈ alkylsulfonic acids, the alkali metal salts and the ammonium salts of C₉-C₁₈ alkylarylsulfonic acid, the alkali metal salts and the ammonium salts of sulfuric acid monoesters of ethoxylated C₁₂-C₁₈ alkanols (EO units: 4-30) or a sulfuric acid monoester of an ethoxylated (C₄-C₁₂ alkyl)phenol (EO units: 3-50).

Further anionic emulsifiers include, without limitation, fatty alcohol phosphates, alkylphenol phosphates, alkyl polyglycol ether phosphates, alkyl polyalkylene oxide phosphates, and fatty alcohol ether phosphates and the salts thereof, in particular the alkali metal salts and ammonium salts thereof, with particular preference given to the alkali metal salts such as sodium salts.

A comprehensive description of suitable emulsifiers may be found in Houben-Weyl, Methoden der organischen Chemie, volume XIV/1, Makromolekulare Stoffe, Georg-Thieme-Verlag, Stuttgart, 1961, pages 192 to 208.

Like the aforementioned emulsifiers, suitable protective colloids may be non-ionic, anionic or cationic. Examples of protective colloids are poly(vinyl alcohols), poly(alkylene glycols), poly(acrylic acids) and the alkali metal salt thereof, poly(methacrylic acids) and the alkali metal salt thereof and gelatin derivatives. Anionic protective colloid can also be a copolymer, containing a suitable amount of at least one anionic monomer, such as acrylic acid, methacrylic acid, maleic acid, 2-acrylamido-2-methylpropane sulfonic acid, para-vinylphenyl sulfonic acid or salt forms thereof, preferably alkali metal salts thereof, in polymerized form. Examples of cationic protective colloids are homo polymers and copolymers containing a sufficient amount of cationic monomers, in particular monoethylenically unsaturated monomers having one or more amino groups, which are N-protonated or N-alkylated.

The protective colloids are distinct from the polymers dispersed in the aqueous polymer dispersion as they are water-soluble or water dispersible. The term “water-soluble or water dispersible” is understood to mean that the corresponding protective colloid can be dissolved or dispersed in deionized water at 20° C. and 1013 mbar in an amount of at least 10 g/L polymer such that the resulting aqueous solution has either no particles of a measurable size or a particles of a size of at most 20 nm as determined by dynamic light scattering in accordance with DIN 22412:2008.

A comprehensive description of suitable protective colloids may be found in Houben-Weyl, Methoden der organischen Chemie, volume XIV/1, Makromolekulare Stoffe, Georg-Thieme-Verlag, Stuttgart, 1961, pages 411 to 420.

As indicated above, the present invention relates in a second aspect, to a powder paint comprising
a) 5 to 30 wt.-% of at least one pigment;
b) 10 to 25 wt.-% of at least one re-dispersible dispersion powder (RDP) comprising
i) at least one (co)polymer selected from the group consisting of acrylic acid ester polymer and acrylic-styrene copolymer and
ii) at least one pyrrolidone-based (co)polymer;
c) 40 to 78 wt.-% of at least one filler;
d) 0 to 2 wt.-% of at least one dispersing agent;
d) 0 to 2 wt.-% of at least one thickener; and
e) 0 to 2 wt.-% of at least one defoamer,
each based on the total dry weight of the powder paint, wherein the pyrrolidone-based (co)polymer is a pyrrolidone-containing polymer (PP) comprising at least one unit of the general formulae (I) to (III)

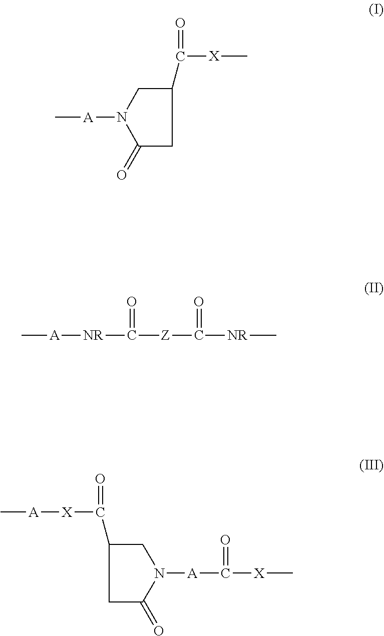

wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl is optionally interrupted by one or more non-adjacent oxygen atoms, sulfur atoms, or functional groups —NR— where the nitrogen atom is optionally protonated or quarternized, —CO—, —CO—O—, —CO—NR—, —SO—, or —SO₂—,
wherein the C₁-C₂₀-alkanediyl and the C₃-C₂₀-cycloalkanediyl optionally carry at least one functional group selected from the group consisting of C(═O)R² and SO₃H, wherein
R² is selected from the group consisting of Cl, Br and OR³, wherein
R³ is selected from the group consisting of H, C₆-C₁₀ alkyl, C₃-C₁₀ cycloalkyl and C₂-C₁₅ alkenyl,
wherein the C₆-C₂₀-arylene is optionally interrupted by oxygen, sulfur, —NR—, —SO—, or —SO₂— and optionally substituted by —COOH or —SO₃H, or a mixture of such groups;
Z is a group of formula (IV)

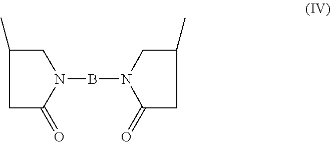

in which B is C₁-C₂₀-alkanediyl, which optionally is interrupted by one or more non-adjacent oxygen atoms, sulfur atoms or functional groups —NR— where the nitrogen atom is optionally protonated or quaternized, —CO—, —CO—O—, —CO—NR—, —SO— or —SO₂—, and optionally carries additional functional groups —COOH or —SO₃H, C₆-C₂₀-cycloalkanediyl or a mixture of such groups
or a mixture of the group of formula (IV) with groups A.

Preferred embodiments (e.g. of the at least one (co)polymer and of the pyrrolidone-containing polymer (PP)) are already disclosed above in relation to the use of the pyrrolidone-based (co)polymer as spray drying aid and are similarly applicable to the powder paints, as well. Particularly preferred embodiment are again disclosed in the following.

In a preferred embodiment, the powder paint comprises
a) 8 to 20 wt.-% of at least one pigment;
b) 10 to 19 wt.-% of at least one re-dispersible dispersion powder (RDP) comprising
i) at least one (co)polymer selected from the group consisting of acrylic acid ester polymer and acrylic-styrene copolymer, preferably acrylic-styrene copolymer, and
ii) at least one pyrrolidone-based (co)polymer;
c) 55 to 78 wt.-% of at least one filler;
d) 0.2 to 2 wt.-% of at least one dispersing agent;
d) 0.5 to 2 wt.-% of at least one thickener; and
e) 0.5 to 2 wt.-% of at least one defoamer,
each based on the total dry weight of the powder paint.

Powder paints comprising ingredients as defined above are particularly suitable as interior paints.

In a preferred embodiment, the powder paint comprises
a) 21 to 30 wt.-% of at least one pigment;
b) 15 to 25 wt.-% of at least one re-dispersible dispersion powder (RDP) comprising
i) at least one (co)polymer selected from the group consisting of acrylic acid ester polymer and acrylic-styrene copolymer, preferably acrylic-styrene copolymer, and
ii) at least one pyrrolidone-based (co)polymer;
c) 40 to 54 wt.-% of at least one filler;
d) 0.2 to 2 wt.-% of at least one dispersing agent;
d) 0.5 to 2 wt.-% of at least one thickener; and
e) 0.5 to 2 wt.-% of at least one defoamer,
each based on the total dry weight of the powder paint.

Powder paints comprising ingredients as defined above are particularly suitable as exterior paints.

In various embodiments, the pyrrolidone-containing polymer (PP) is obtainable by polymerization of a reactive mixture (rM1), wherein the reactive mixture (rM1) comprises at least the following components:
(A) at least one itaconic acid derivative, preferably wherein component (A) is selected from the group consisting of itaconic acid, itaconic anhydride, itaconic esters and itaconyl halides, and
(B) at least one diamine, preferably wherein the diamine is selected from the group consisting of ethylenediamine, 1,3-diaminopropane, 1,4-diaminobutane, 1,5-pentanediamine, 1,6-diaminohexane, 1,7-diaminoheptane, 1,8-diaminooctane, and 1,9-diaminononane, more preferably ethylenediamine and 1,5-pentanediamine.

In a preferred embodiment, the reactive mixture (rM1) comprises at least two diamines, preferably selected from the group consisting of ethylenediamine, 1,3-diaminopropane, 1,4-diaminobutane, 1,5-pentanediamine, 1,6-diaminohexane, and 1,7-diaminoheptane, and in particular wherein the reactive mixture (rM1) comprises ethylenediamine and 1,5-pentanediamine.

In a preferred embodiment, the pyrrolidone-containing polymer (PP) is obtainable by polymerization of a reactive mixture (rM2), wherein the reactive mixture (rM2) comprises at least the following components:
(A) at least one itaconic acid derivative, preferably wherein component (A) is selected from the group consisting of itaconic acid, itaconic anhydride, itaconic esters and itaconyl halides, and
(B) at least one amino acid of the general formula (1)

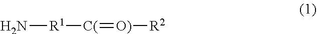

wherein
R¹ is selected from the group consisting of at least monosubstituted C₂-C₂₀-alkanediyl and at least monosubstituted C₃-C₂₀-cycloalkanediyl, wherein the substituent is NH₂;
R² is selected from the group consisting of Cl, Br and OR³, wherein
R³ is selected from the group consisting of H, C₁-C₁₀ alkyl, C₃-C₁₀ cycloalkyl and C₂-C₁₅ alkenyl, preferably wherein component (B) is selected from the group consisting of L-Lysine, D-Lysine and racemic mixtures of L-Lysine and D-Lysine.

In a preferred embodiment, the at least one pigment is an inorganic white pigment, preferably selected from the group consisting of titanium dioxide, preferably in the rutile form, barium sulfate, zinc oxide, zinc sulfide, basic lead carbonate, antimony trioxide, and lithopone (zinc sulfide and barium sulfate) or and inorganic colored pigment, more preferably selected from the group consisting iron oxides, carbon black, graphite, zinc yellow, zinc green, ultramarine, manganese black, antimony black, manganese violet, Prussian blue and Parisian green, in particular titanium dioxide.

In a preferred embodiment, the at least one pigment is an organic pigment. Suitable organic color pigments are, for example sepia, gamboge, Cassel brown, toluidine red, para red, Hansa yellow, indigo, azo dyes, anthraquinonoid and indigoid dyes and also dioxazine, quinacridone, phthalocyanine, isoindolinone and metal-complex pigments. Also useful are the Luconyl® brands from BASF SE, e.g., Luconyl® yellow, Luconyl® brown and Luconyl® red, especially the transparent versions. In a preferred embodiment, the powered paint comprises an organic pigment, wherein the organic pigment is in the form of hollow organic particles and/or is based on polymers, comprising nonionic ethylenically unsaturated monomers, preferably wherein the nonionic ethylenically unsaturated monomer is selected from the group consisting of styrene, acrylonitrile, methacrylamide, methyl methacrylate, ethyl acrylate, ethyl methacrylate, butyl acrylate, butyl methacrylate, 2-ethylhexyl acrylate, 2-ethylhexyl methacrylate, or mixtures thereof.

In various embodiments, the above disclosed inorganic and organic pigments may also be used in combination.

Suitable fillers include, for example, matting agents to substantially reduce gloss in a desired manner. Matting agents are generally transparent and may be not only organic but also inorganic. Inorganic fillers based on silica are most suitable and are widely available commercially. Examples are the Syloid® brands of W.R. Grace & Company and the Acematt® brands of Evonik Industries AG. Organic matting agents are for example available from BYK-Chemie GmbH under the Ceraflour® and the Ceramat® brands, from Deuteron GmbH under the Deuteron MK® brand. Suitable fillers for emulsion paints further include aluminosilicates, such as feldspars, silicates, such as kaolin, talc, mica, magnesite, alkaline earth metal carbonates, such as calcium carbonate, for example in the form of calcite or chalk, magnesium carbonate, dolomite, alkaline earth metal sulfates, such as calcium sulfate, silicon dioxide, etc. The preference in paints is naturally for finely divided fillers. The fillers can be used as individual components. In practice, however, filler mixtures have been found to be particularly advantageous, examples being calcium carbonate/kaolin and calcium carbonate/talc. Gloss paints generally include only minimal amounts of very finely divided fillers or contain no fillers at all.

Finely divided fillers can also be used to enhance the opacity and/or to economize on white pigments. Blends of fillers and color pigments are preferably used to control the opacity of the hue/color and of the depth of shade (color strength).

In a preferred embodiment, the at least one filler is selected from the group consisting of calcium carbonate, precipitated calcium carbonate, talc, mica, silica, alumina silicate, nepheline syenite, clay, calcinated clay, feldspar, and mixtures thereof.

Suitable dispersing agents are, for example, sodium polyphosphates, potassium polyphosphates, ammonium polyphosphates, alkali metal and ammonium salts of (meth)acrylic acid copolymers or of maleic anhydride copolymers, polyphosphonates, such as sodium 1-hydroxyethane-1,1-diphosphonate, and also naphthalenesulfonic acid salts, in particular their sodium salts.

In a preferred embodiment, the at least one dispersing agent is a sodium salt of a carboxylic acid copolymer in water or a copolymer of maleic acid and an olefin as the sodium salt, preferably a sodium salt of a carboxylic acid copolymer in water. Dispersing agents may be present in the powder paint in an amount of 0.1 to 2 wt %, preferably of 0.2 to 1 wt %, based on the total weight of the formulation. Preferably, the amount is adjusted to the used fillers.

Suitable defoamers include, for example and without limitation, hydrophobic materials such as silicones, polysiloxanes, mineral oil, plant oil, and white oil, which are often offered in powder form in combination with surface-active substances (e.g. FoamStar PB 2922) and are typically bonded to a carrier substance such as silica (e.g. Agitan P 804).

In a preferred embodiment, the at least one defoamer is a modified polysiloxane.

Useful thickeners include, for example, associative thickeners, such as polyurethane thickeners. The amount of thickener is preferably less than 2.5 wt %, more preferably less than 1.5 wt % of thickener, based on paint solids content. Further guidance regarding the formulation of wood paints can be found described at length in “Water based acrylates for decorative coatings” by the authors M. Schwartz and R. Baumstark, ISBN 3-87870-726-6. Further suitable thickeners include, for example, acrylic thickener, cellulose ether, chemical modified cellulose derivatives (cellulosics—hydroxyethyl cellulose (HEC), carboxymethyl celluloses (CMC), hydroxypropyl methylcellulose, methylcellulose, hydroxypropyl cellulose, ethylhydroxyethyl cellulose, and others—chemically substituted cellulose macromolecules), hydrophobic modified polyether (HMPE), gums, saccharides, polysaccharides, and polyvinyl alcohol.

In a preferred embodiment, the at least one thickener is a hydroxyethylcellulose (HEC), preferably having a weight average molecular weight (Mw; determined by gel permeation chromatography (GPC) with 0.05 M aqueous ammonium formate/methanol mixture=80:20 (parts by volume) as eluent) of 1,000 to 100,000 g/mol, more preferably of 5,000 to 60,000 g/mol, still more preferably of 10,000 to 50,000 g/mol, and in particular of 15,000 to 25,000 g/mol.

The powder paint may further comprise film-forming agents. Suitable film-forming agents include, without limitation, Texanol® from Eastman Chemicals and the glycol ethers and esters commercially available, for example from BASF SE, under the trade names Solvenon® and Lusolvan®, and from Dow Chemicals under the tradename Dowanol®. The amount is preferably <10 wt % and more preferably <5 wt %, based on overall formulation weight. It is also possible to formulate entirely without solvents or such film-forming agents.

Wetting agents may also be included in the powder paints of the invention. Suitable wetting agents include, without limitation, non-ionic surfactants such as non-ionic, ethoxylated fatty alcohol-based surfactant or non-ionic, propoxylated fatty alcohol-based surfactant (e.g. Lumiten N-OG). Wetting agents may be present in the powder paint in an amount of 0.1 to 2 wt %, preferably of 0.2 to 1 wt %, based on the total weight of the formulation. Preferably, the amount is adjusted to the used fillers.

Further information on paint formulations can be found in the textbooks “Additives for Water-borne Coatings” from Wernfried Heilen et al.; Vincentz-Verlag 2021; 978-3-7486-0486-0 (ISBN) and in “Waterbased Acrylates for Decorative Coatings” from Manfred Schwartz, Roland Baumstark; Vincentz Press, 2001 in chapter 2).

As indicated above, the present invention relates in a third aspect to a process of manufacturing a paint or producing a usable paint, the process comprising mixing the powder paint described herein with a suitable solvent, for example water, in an amount to preferably adjust a solid content of 45 to 70 wt.-%, more preferably of 50 to 65 wt.-%, based on the total weight of the paint.

The paints of the invention are produced in a known manner by blending the components in customary mixers. A tried and tested procedure is to first prepare an aqueous paste or dispersion from the pigments, water and optionally auxiliaries and only then to mix the polymeric binder, i.e., typically the/an aqueous dispersion of the polymer, with the pigment paste and pigment dispersion, respectively.

The paint of the invention can be applied to substrates in a conventional manner, e.g., by brushing, spraying, dipping, rolling or knifecoating.

Preferred embodiments (e.g. of the at least one (co)polymer and of the pyrrolidone-containing polymer (PP)) have already been disclosed above in relation to inventive use of the pyrrolidone-based (co)polymer as spray drying aid and similarly apply to the paint of the invention and vice versa. Particularly preferred embodiment are again mentioned in the following.

Preferably, the process comprises stirring the mixture.

Preferably, the process comprises mixing the above-outlined powder paints with deionized water.

Further disclosed and encompassed by the invention are paints obtainable or obtained by the above-described process of manufacturing a paint.

### EXAMPLES

The invention is illustrated in further detail by the following examples, which are intended as illustrative but not limiting.

### Starting Materials and Methods

Itaconic acid was purchased form Sigma-Aldrich (>99% purity)
L-Lysine (ADM, 50% water solution if specifically not stated otherwise, purity>98%, is used)

Weight average molecular weight (Mw) was determined by gel permeation chromatography (GPC) with 0.05 M aqueous ammonium formate/methanol mixture=80:20 (parts by volume) as eluent.

Number average molecular weight (Mn) was determined by gel permeation chromatography (GPC) with 0.05 M aqueous ammonium formate/methanol mixture=80:20 (parts by volume) as eluent.

Determination of the molecular weight (Mass average molar mass (Mw) and number average molar mass (Mn)) of the polymers was performed as follows: The sample was prepared for the determination of molar mass by dissolving copolymer solution in the GPC eluent, such that the polymer concentration in the GPC eluent is 0.5% by weight. Thereafter, this solution was filtered through a syringe filter having a polyether sulfone membrane and pore size 0.45 μm. The injection volume of this filtrate was 50-100 μL. The average molecular weights were determined on a Waters GPC instrument with the model name Alliance 2690 with a UV detector (Waters 2487) and RI detector (Waters 2410). The following settings and conditions were used:
Columns: Shodex SB-G Guard Column for SB-800 HQ series and Shodex OHpak SB 804HQ and 802.5HQ (PHM gel, 8×300 mm, pH 4.0 to 7.5)
Eluent: 0.05 M aqueous ammonium formate/methanol mixture=80:20 (parts by volume)
Flow rate: 0.5 mL/min
Temp.: 50° C.
Injection: 50 to 100 μL
Detection: RI and UV

Depending on the nature of the copolymers, their molecular weights were determined relative to poly(ethylene glycol) and poly(ethylene oxide) or polyacrylic acid standards from PSS Polymer Standards Service GmbH. The molecular weight distribution curves of the polyacrylic acid standards were determined by means of light scattering.

### Amino Number:

The amino number (unit: mg KOH/g) was determined by titration. A potentiograph equipped with a Dosimat with 10 ml interchangeable burette and a combined glass-Ag/AgCl-electrode, e. g. titroprocessor type 726 with Dosimat 685 (Metrohm), was used. About 0.1 to 1.0 g of sample (the exact mass was chosen according to the expected amine number) were mixed with 50 ml of glacial acetic acid in a 100 ml beaker to obtain a solution. The solution was titrated with 0.1 N trifluoromethanesulfonic acid (standard solution in glacial acetic acid, c(CF3SO3H)=0.1 mol/l) until the inflection point at a potential of about 600 mV was reached. A blank value was determined using the solvent.

### Calculation of the Amine Number:

$$Amine number = \frac{( {V}_{P} - {V}_{B} ) \cdot t \cdot c \cdot 56.1}{E} = \frac{( {V}_{P} - {V}_{B} ) \cdot t}{E} \cdot 5.61$$

with
Amine number: Fraction of total amine calculated as mg KOH/g
VP: Consumption of standard solution up to the inflection point [ml]
VB: Consumption of standard solution in blank value titration [ml]
t: titer of standard solution
c: concentration of standard solution [=0.1 mol/l]
E: weight of sample taken [g]
56.1 is the molar weight of KOH [g/mol]

For the examples and comparative examples, the following materials and starting materials were used:

### Spray Drying Aids:

### Spray Drying Aid 1:

Commercially available polyvinylpyrrolidone (PVP), which is manufactured by BASF and is available under the trade name Luvitec® K 17. This polymer has a molecular weight of M_{W} 9 kDa and M_{N} 2 kDa.

### Spray Drying Aid 2:

Commercially available polyvinylpyrrolidone (PVP), which is manufactured by Sigma-Adrich and is available under the trade name PVP10. This polymer has a molecular weight of M_{W} 10 kDa.

### Spray Drying Aid 3:

Commercially available polyvinylpyrrolidone (PVP), which is manufactured by BASF and is available under the trade name Luvitec® K 30. This polymer has a molecular weight of M_{W} 50 kDa and M_{N} 14 kDa.

### Spray Drying Aid 4:

Commercially available polyvinylpyrrolidone (PVP), which is manufactured by BASF and is available under the trade name Luvitec® K 90. This polymer has a molecular weight of M_{W} 1400 kDa and M_{N} 325 kDa.

### Spray Drying Aid 5:

Commercially available copolymer of vinyl pyrrolidone and vinyl acetate, which is manufactured by BASF and is available under the trade name Luvitec® VA 64. This polymer has a molecular weight of M_{W} 65 kDa and M_{N} 15 kDa.

### Spray Drying Aid 6:

In a reaction vessel (four-necked flask) equipped with reflux condenser, stirrer, thermometer, dropping funnel, and nitrogen sparging, a solution of 520.4 g itaconic acid, 123.6 g ethylenediamine, and 500 mL water was stirred and heated under reflux for one hour. Afterwards, 208.5 g of 1,5-pentanediamine was added. The water was removed trough a distillation apparatus under normal pressure and later by applying a vacuum. In parallel, the reaction mixture was slowly heated to 180° C. At a vacuum of <2 mbar, the reaction was continued until the stirrer showed a torque of 20 Ncm. The obtained polymer has a K-value of 20.6, a molecular weight of M_{W}˜5020 g/mol, and M_{N}˜2350 g/mol.

### Spray Drying Aid 7:

In an analogous way to the synthetic procedure as described for the spray drying aid 1, the spray drying aid 2 was synthesized using 339.9 g itaconic acid and 133.5 g 1,5-pentanediamine. Afterwards, 39.5 g ethylenediamine and 67.1 g of 1,5-pentanediamine were added. Followed by the same treatment, as described for spray drying aid 1. The obtained polymer has a K-value of 18.6, a molecular weight of M_{W}˜4690 g/mol, and M_{N}˜2190 g/mol.

### Spray Drying Aid 8:

In an analogous way to the synthetic procedure as described for the spray drying aid 1, the spray drying aid 3 was synthesized using 390.3 itaconic acid and 92.0 g ethylenediamine. Afterwards, 46.0 g ethylenediamine and 78.2 g of 1,5-pentanediamine were added. Followed by the same treatment, as described for spray drying aid 1. The obtained polymer has a K-value of 16.5, a molecular weight of M_{W}˜4360 g/mol, and M_{N}˜2010 g/mol.

### Spray Drying Aid 9:

526.32 g of 50% water solution of L-Lysine (1.8 mol) were placed in a 2 L four-necked flask equipped with a stirrer a condensation column, a thermometer, and a Nitrogen inlet. To the L-Lysine solution 117.09 g of itaconic acid (0.9 mol) were added. The mixture was heated under stirring and under inert atmosphere (N2 flow) to the boiling point and kept under reflux for 10 h. Then, the temperature of the external heat source was increased according to the following profile 1 h at 150° C., 1 h at 160° C., 1 h at 170° C., and 1 h at 180° C. while water was distilled off. The warm reaction melt was collected in an aluminum vessel. At room temperature, a solid material was obtained. The obtained polymer has an amino number of 308 mg KOH/g. The polymer has a molecular weight of M_{W}˜2410 g/mol, and M_{N}˜2175 g/mol.

### (Ref.) Spray Drying Aid 10:

Commercially available polyacrylamide (PAM; catalog No. 22581) in water, which is manufactured by Polysciences Inc. The polymer has a solids content of 50% by weight and a molecular weight of M_{W}˜10000 g/mol.

### (Ref.) Spray Drying Aid 11:

In a reaction vessel equipped with reflux condenser, stirrer, thermometer, dropping funnel, and nitrogen sparging, an initial charge of 280 g of water and 195 g of Na-2-acrylamido-2-methylpropanesulfonic acid (AMPS) was heated to 18° C. While stirring, 70 g of a 50% sodium hydroxide solution were added dropwise at 18° C. Subsequently, 68 g of acrylic acid, 2.8 g of 2,2′-azobis(2-methylpropionamidine) dihydrochloride (Wako V50) and 4 g of mercaptoethanol were metered in while stirring over a period of 10 min. The reaction solution was stirred at 70 to 80° C. for 1.5 h and then cooled down to room temperature. The resulting product was a clear polymer solution having a solids content of 48.1% by weight, a pH of 0.8, and a molecular weight M_{W} of about 8400 g/mol.

### (Ref.) Spray Drying Aid 12:

In a reaction vessel equipped with reflux condenser, stirrer, thermometer, dropping funnel, and nitrogen sparging, an initial charge of 350 g of water and 313 g of Na-2-acrylamido-2-methylpropanesulfonic acid (AMPS) was heated to 18° C. While stirring, 112 g of a 50% sodium hydroxide solution were added dropwise at 18° C. Subsequently, 27 g of acrylic acid, 2.8 g of 2,2′-azobis(2-methylpropionamidine) dihydrochloride (Wako V50) and 6 g of mercaptoethanol were metered in while stirring over a period of 14 min. The reaction solution was stirred at 70 to 80° C. for 1.5 h and then cooled down to room temperature. The resulting product was a clear polymer solution having a solids content of 48.5% by weight, a pH of 0.8, and a molecular weight M_{W} of about 7400 g/mol.

### (Ref.) Spray Drying Aid 13: Poval® 4-88

Commercially available partially saponified polyvinyl alcohol (PVOH), is a solid, has a degree of hydrolysis of 86.7-88.7 mol %, non-volatile parts of 97.5±2.5% (measured after a drying time of 3 hours at 105° C. according to DIN 53189/JIS K 6726), and has a viscosity of 3.5-4.5 mPa*s as a 4% aqueous solution at 20° C. (according to DIN 53015/JIS K 6726). The polymer is manufactured by Kuraray and is available under the trade name Poval® 4-88.

### (Ref.) Spray Drying Aid 14:

A polyacid based on the monomers methacrylic acid and 2-methyl-2-propene-1-sulfonic acid. This polyacid has a molecular weight of M_{W}˜1400 g/mol and was synthesized as described in US 2020/0207671 A1 page 10, paragraph [0234] to paragraph [0235].

### (Ref.) Spray Drying Aid 15:

A polyacrylic acid having a pH of ˜2 and a molecular weight M_{W} of 5000 g/mol, which is manufactured by BASF and is available under the Sokalan PA 25 XS trade name.

### (Ref.) Spray Drying Aid 16:

A phenol sulfonic acid-formaldehyde condensation product with a molecular weight of MW˜8000 g/mol was synthesized as described in WO 98/03576 A1 page 14, line 42 to page 15, line 12.

### Aqueous Dispersions

### Dispersion 1:

The dispersion was synthesized according to a styrene-acrylate as described in US 2020/0207671 A1: Dispersion 1 at page 9. The obtained polymer has a solids content of 55% by weight, a glass transition temperature of −15° C., and a particle size of about 600 nm.

### Dispersion 2:

The dispersion is based on the same composition as dispersion 1 and additionally comprises 3 parts per hundred monomers (pphm) methoxy polyethylene glycol (MPEG) with a M_{W} of 750 g/mol and 2.5 pphm acrylic acid. The obtained polymer has a solids content of 54.6% by weight, a glass transition temperature of −15° C., and a particle size of about 730 nm.

### Dispersion 3:

The dispersion was synthesized according to a styrene-acrylate dispersion which was produced by emulsion polymerization as described in WO 2013/117465 A1: Example “Polymerisatdispersion D” on page 19-20. The dispersion has a solids content of 57% by weight, a glass transition temperature of −13° C., and a particle size of 230 nm.

### Dispersion 4:

The dispersion based on styrene-acrylate. The polymer has a solids content of 60% by weight, a glass transition temperature of −8 to −10° C., and a particle size of about 550 nm. The dispersion comprises 68.5 pphm n-butyl acrylate, 28.5 pphm styrene, and 3 pphm acrylic acid. The dispersion is stabilized by 2 wt.-% emulsifier (fatty alcohol (C12-C14) ether sulfates having an ethoxylation degree of ˜30 EO units.

### Spray-Drying of Dispersions

### A) Preparation of the Spray-Dying Feed:

For making the dispersions to be spray dried, the aqueous polymer dispersion chosen (a as described above) was mixed with the spray drying aid chosen (selected from spray drying aids No. 1 to No. 16 as described above) while stirring. Additionally, the spray feed can be mixed with a dispersing aid, such as a sodium salt of a carboxylic acid copolymer in water (Dispex CX 4320) or a copolymer of maleic acid and an olefin as the sodium salt of maleic acid/olefin copolymer in powdered form. The amounts of spray drying aid used are shown in Table 1.

Additional water was used to adjust the concentration of the dispersion to be dried to 44 wt.-% relating to the solids content in the spray feed.

### B) Spray Drying of the Dispersion:

Spray drying was conducted by means of a commercially available, laboratory-scale spray dryer (Niro Atomizer from Niro) using nitrogen as drying gas. The aqueous dispersion to be dried was sprayed through a two-fluid nozzle. The inlet temperature of the dryer gas was 130 to 140° C.; its outlet temperature was 60 to 70° C. A first anti-blocking agent (1 wt.-%) of hydrophobic silica powder, based on the total of all components of the final product) was fed into the drying chamber through an additional nozzle.

After removing the obtained powder from the spray dryer, it was mixed with 9-10 wt.-% (based on the total of all components of the final product) of a second anti-blocking agent (talc).

### Pre-Test: Determination of the Re-Dispersibility

The composition composed of a dispersion with spray-drying aid (SDA) specified in Table 1 was used to produce films and their re-dispersion was tested. For this purpose, the liquid dispersion (5 g of solids) in 10-15 mL of water was admixed with the described amount of the respective SDA and dried at room temperature for two days. About 0.5 g of the film was taken up in 10 mL of distilled water while stirring (200 rpm) at room temperature. On rapid re-dispersion within a few minutes, it was found that these dispersion systems also have excellent spray-dry ability and a re-dispersible powder (RDP) is obtained.

Re-dispersion was assessed as follows:
Complete re-dispersion within a few minutes: very good
Virtually complete re-dispersion within a few minutes: good
Incomplete re-dispersion (parts of the film/powder are still apparent): moderate
Large parts of the film/powder are insoluble or no re-dispersion: poor

TABLE 1
Re-dispersibility of the different combinations
of dispersions and SDA as film and as RDP

| | | | | Amount of | | |
|---|---|---|---|---|---|---|
| | | | Amount of | dispersing | | |
| | | | SDA to s.c.* | aid to s.c.* | | |
| | | | of the | of the | Re-dispersibility of | |
| Combination | Dispersion | SDA | dispersion | dispersion | the film | the RDP |
| 1 | 1 | 1 | 10% | 0 | very good | very good |
| 2 | 1 | 2 | 10% | 0 | very good | very good |
| 3 | 1 | 3 | 10% | 0 | very good | very good |
| 4 | 1 | 4 | 10% | 0 | moderate | moderate |
| 5 | 1 | 1 | 10% | 4% | very good | very good |
| 6 | 1 | 3 | 10% | 4% | very good | very good |
| 7 | 1 | 1 | 7% | 0 | very good | very good |
| 8 | 1 | 3 | 7% | 0 | very good | very good |
| 9 | 1 | 1 | 7% | 4% | very good | very good |
| 10 | 1 | 3 | 7% | 4% | very good | very good |
| 11 | 1 | 1 | 5% | 4% | very good | very good |
| 12 | 1 | 3 | 5% | 4% | very good | very good |
| 13 | 1 | 5 | 7% | 0 | very good | very good |
| 14 | 4 | 5 | 10% | 0 | very good | very good |
| 15 | 1 | 6 | 15% | 0 | very good | very good |
| 16 | 1 | 6 | 10% | 0 | very good | very good |
| 17 | 1 | 7 | 10% | 0 | very good | good |
| 18 | 1 | 7 | 6% | 4% | very good | very good |
| 19 | 1 | 8 | 6% | 4% | moderate | good |
| 20 | 2 | 9 | 10% | 0 | good | very good |
| 21 | 3 | 6 | 10% | 0 | good | good |
| 22 | 4 | 9 | 10% | 0 | good- | good- |
| | | | | | moderate | moderate |
| 23 | 1 | 10 | 10% | 0 | poor | n.d.** |
| 24 | 3 | 10 | 10% | 0 | poor | n.d.** |
| 25 | 4 | 10 | 10% | 0 | poor | n.d.** |
| 26 | 1 | 11 | 10% | 0 | poor | n.d.** |
| 27 | 1 | 12 | 10% | 0 | poor | n.d.** |
| 28 | 1 | 11 | 10% | 0 | poor | n.d.** |
| 29 | 1 | 12 | 10% | 0 | poor | n.d.** |
| 30 | 3 | 11 | 10% | 0 | poor | n.d.** |
| 31 | 3 | 12 | 10% | 0 | poor | n.d.** |
| 32 | 4 | 11 | 10% | 0 | poor | n.d.** |
| 33 | 1 | 13 | 10% | 0 | poor | n.d.** |
| 34 | 3 | 13 | 10% | 0 | poor | n.d.** |
| 35 | 4 | 13 | 10% | 0 | poor | n.d.** |
| 36 | 1 | 14 | 10% | 0 | very good | very good |
| 37 | 1 | 15 | 10% | 0 | very good | very good |
| 38 | 1 | 16 | 10% | 0 | very good | very good |

*s.c. = solids content
**n.d. = not determined

Only combinations were spray-dried when the pre-test was better or equal to a moderate re-dispersing film in water. As it can be seen from the Table 1, the combination of styrene-acrylate dispersions with vinylpyrrolidone based homo- and copolymers leads to re-dispersible films and re-dispersible powders. This is also true for the combination of styrene-acrylate dispersions with polycondensates of itaconic acid and diamines/lysine.

Although polyvinyl alcohol (PVOH, spray-drying aid 13) is a common protective colloid and spray-drying additive for dispersions based on a copolymer of vinyl acetate and ethylene (EVA) and as well as for terpolymers of vinyl acetate, ethylene, and vinyl esters, the combination of the styrene-acrylate dispersions used here with polyvinyl alcohol (PVOH) as SDA was not suitable and neither re-dispersible films nor re-dispersible dispersion powders were obtained.

Possible explanation: For the compatibility of the dispersion with the SDA, the nature of stabilization is important and also the presence/absence of a protective colloid (such as polyvinyl alcohol; PVOH) during the emulsion polymerization could play a role. In the case of using PVOH as a protective colloid during the emulsion polymerization and as SDA, a suitable combination for spray-drying is obtained.

Other amide-based SDAs, such as polyacrylamide (spray drying aid 10) and the AMPS-containing copolymers (spray drying aid 11 and 12), show neither re-dispersible films nor re-dispersible dispersion powders with the styrene-acrylate dispersions.

The polyacid-based SDAs (spray drying aid 14, 15, and 16) in combination of the styrene-acrylate dispersions showed very good re-dispersible films and powders.

### Application Tests

The influence of re-dispersible powders on the wet scrub resistance in a paint formulation was investigated according to EN 13300. Therefore, a dry formulation was produced according to Table 2 and mixed with 365.00 weight parts deionized water.

TABLE 2
Paint formulation (dry).

| Function / Constituents | weight parts |
|---|---|
| Base thickener, HEC, Mw 20000 | 4.00 |
| Dispersing agent (sodium salt of | 3.00 |
| a carboxylic acid copolymer in | |
| water; Dispex CX 4320) | |
| Defoamer (modified | 4.00 |
| polysiloxane) | |
| Rutile; titanium dioxide | 60.00 |
| Filler, fine alumina silicate | 20.00 |
| Filler, precipitated calcium | 50.00 |
| carbonate PCC | |
| Platelet filler, talc | 90.00 |
| Filler, calcite 2 μm | 80.00 |
| Filler, calcite 5 μm | 230.00 |
| Dispersion powder | 94.00 (latex content) |

If the dispersing agent was already co-spray dried with the dispersion, the dispersing agent has been removed from the formulation.

The wet scrub resistance was investigated according to EN 13300. The lower the abrasion after 200 cycles, the better is the paint formulation. The aqueous dispersions which were used for the RDPs showed the lowest abrasion, because no additional water-soluble polymer (SDA) without a function for the paint system is present.

TABLE 3
Wet scrub resistance of the formulation with RDPs; “X”
denotes that neither a combination nor an SDA was added.

| Example | Combination | Dispersion | SDA | Scrub [μm]*** |
|---|---|---|---|---|
| Reference 1 | X | 1 | X | 19 |
| Reference 2 | X | 4 | X | 36 |
| Example 1 | 1 | 1 | 1 | 50 |
| Example 2 | 2 | 1 | 2 | 42 |
| Example 3 | 3 | 1 | 3 | 33 |
| Example 4 | 4 | 1 | 4 | n.d.** |
| Example 5 | 5 | 1 | 1 | 39 |
| Example 6 | 6 | 1 | 3 | 54 |
| Example 7 | 7 | 1 | 1 | 40 |
| Example 8 | 8 | 1 | 3 | 31 |
| Example 9 | 9 | 1 | 1 | 43 |
| Example 10 | 10 | 1 | 3 | 35 |
| Example 11 | 11 | 1 | 1 | 56 |
| Example 12 | 12 | 1 | 3 | 27 |
| Example 13 | 13 | 1 | 5 | 73 |
| Example 14 | 14 | 4 | 5 | 58 |
| Example 15 | 15 | 1 | 6 | 32 |
| Example 16 | 16 | 1 | 6 | 29 |
| Example 17 | 17 | 1 | 7 | n.d.** |
| Example 18 | 18 | 1 | 7 | 45 |
| Example 19 | 19 | 1 | 8 | 46 |
| Example 20 | 20 | 2 | 9 | 46 |
| Example 21 | 21 | 3 | 6 | 36 |
| Example 22 | 22 | 4 | 9 | 63 |
| Ref.-Example 23 | 36 | 1 | 14 | 71 |
| Ref.-Example 24 | 37 | 1 | 15 | 130 |
| Ref.-Example 25 | 38 | 1 | 16 | 46 |

**n.d. = not determined
***after 200 cycles

In case of a phenol sulfonic acid-formaldehyde condensation product as SDA (spray drying aid 16), the resulting RDP was brownish and, therefore, not suitable for a powder paint.

In case of the polyacid-based SDAs (spray drying aid 14 and 15), the resulting RDP is acidic and have to be neutralized in a paint formulation, as described in DE 19601699 A1. Further, the wet-scrub resistance is inferior compared to the polymers of this invention. If the polycarboxylic acids are neutralized before spray-drying the dispersion, the resulting dispersion powder re-disperses poorly, as described in WO 2018/224519.

Altogether, the inventive powder paints surprisingly provide well-balanced properties when it comes to the re-dispersibility, wet scrub resistance, and the visual requirements.

1.-15. (canceled)

16. A spray drying aid for powder paint comprising at least one re-dispersible dispersion powder (RDP), wherein the re-dispersible dispersion powder comprises
i) a (co)polymer selected from the group consisting of acrylic acid ester polymer, acrylic-styrene copolymer, styrene-butadiene-based copolymer, and mixtures thereof, and
ii) a pyrrolidone-based (co)polymer.

17. The spray drying aid according to claim 16, wherein the pyrrolidone-based (co)polymer is a homo N-vinylpyrrolidone or a copolymerisate of N-vinylpyrrolidone and vinyl acetate.

18. The spray drying aid according to claim 16, wherein the pyrrolidone-based (co)polymer is a pyrrolidone-containing polymer (PP) comprising at least one unit of the general formulae (I) to (III) 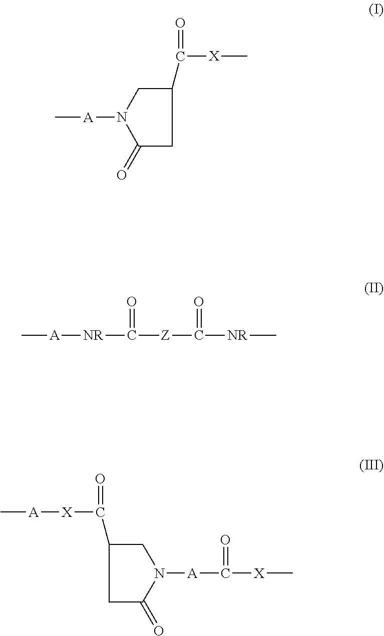
wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl can be optionally interrupted by one or more non-adjacent oxygen atoms, sulfur atoms, or functional groups —NR— where the nitrogen atom can be optionally protonated or quarternized, —CO—, —CO—O—, —CO—NR—, —SO—, or —SO₂—,
wherein the C₁-C₂₀-alkanediyl and the C₃-C₂₀-cycloalkanediyl can optionally carry at least one functional group selected from the group consisting of C(═O)R² and SO₃H, wherein
R² is selected from the group consisting of Cl, Br and OR³, wherein
R³ is selected from the group consisting of H, C₁-C₁₀-alkyl, C₃-C₁₀ cycloalkyl and C₂-C₁₅-alkenyl,
wherein the C₆-C₂₀-arylene can be optionally interrupted by oxygen, sulfur, —NR—, —SO—, or —SO₂—and can be optionally substituted by —COOH or —SO₃H, or a mixture of such groups;
Z is a group of formula (IV) 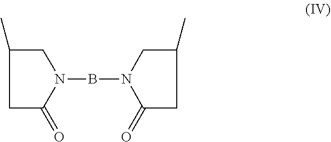
in which B is C₁-C₂₀-alkanediyl, which can be optionally interrupted by one or more non-adjacent oxygen atoms, sulfur atoms or functional groups —NR— where the nitrogen atom can be optionally protonated or quaternized, —CO—, —CO—O—, —CO—NR—, —SO— or —SO₂—, and can optionally carry additional functional groups —COOH or —SO₃H, C₆-C₂₀-cycloalkanediyl or a mixture of such groups
or a mixture of the group of formula (IV) with groups A.

19. The spray drying aid according to claim 18, wherein the pyrrolidone-containing polymer (PP) is formed by polymerization of a reactive mixture (rM1), wherein the reactive mixture (rM1) comprises:
(A) at least one itaconic acid derivative, and
(B) at least one diamine.

20. The spray drying aid according to claim 18, wherein the pyrrolidone-containing polymer (PP) is formed by polymerization of a reactive mixture (rM2), wherein the reactive mixture (rM2) comprises:
(A) at least one itaconic acid derivative, and
(B) at least one amino acid of the general formula (1) 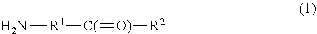
wherein
R¹ is selected from the group consisting of at least monosubstituted C₂-C₂₀ alkanediyl and at least monosubstituted C₃-C₂₀-cycloalkanediyl, wherein the substituent is NH₂;
R² is selected from the group consisting of C, Br and OR³, wherein
R³ is selected from the group consisting of H, C₁-C₁₀-alkyl, C₃-C₁₀-cycloalkyl and C₂-C₁₅-alkenyl.

21. The spray drying aid according to claim 16, wherein the powder paint comprises at least one inorganic pigment or at least one organic pigment.

22. The spray drying aid according to claim 16, wherein the (co)polymer is an acrylic-styrene copolymer, wherein the acrylic-styrene copolymer has a Tg, calculated using the Fox equation, of −60 to 20° C., and has an average particle size (D 50 value) of the polymer particles as measured by dynamic light scattering of 50 to 1000 nm.

23. A powder paint comprising
a) 5 to 30 wt.-% of at least one pigment;
b) 10 to 25 wt.-% of at least one re-dispersible dispersion powder (RDP) comprising
i) at least one (co)polymer selected from the group consisting of acrylic acid ester polymer and acrylic-styrene copolymer and
ii) at least one pyrrolidone-based (co)polymer;
c) 40 to 78 wt.-% of at least one filler;
d) 0 to 2 wt.-% of at least one dispersing agent;
e) 0 to 2 wt.-% of at least one thickener; and
f) 0 to 2 wt.-% of at least one defoamer,
each based on the total dry weight of the powder paint, wherein the pyrrolidone-based (co)polymer is a pyrrolidone-containing polymer (PP) comprising at least one unit of the general formulae (I) to (III) 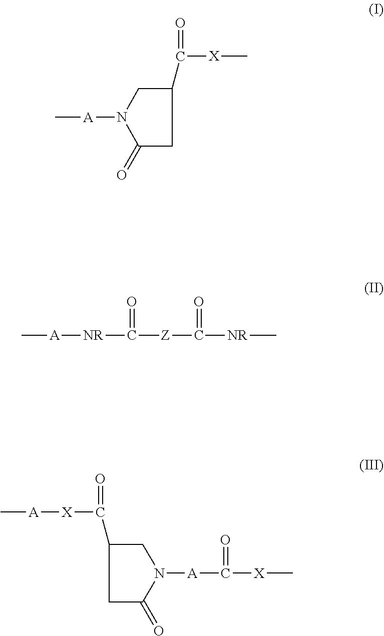
wherein R is independently hydrogen, C₁-C₄-alkyl, or two radicals R are linked to one another to form a six-membered ring;
X is —O— or —NR;
A is independently selected from the group consisting of C₁-C₂₀-alkanediyl, C₃-C₂₀-cycloalkanediyl, and C₆-C₂₀-arylene,
wherein the C₁-C₂₀-alkanediyl can be optionally interrupted by one or more non-adjacent oxygen atoms, sulfur atoms, or functional groups —NR— where the nitrogen atom can be optionally protonated or quarternized, —CO—, —CO—O—, —CO—NR—, —SO—, or —SO₂—,
wherein the C₁-C₂₀-alkanediyl and the C₃-C₂₀-cycloalkanediyl can optionally carry at least one functional group selected from the group consisting of C(═O)R² and SO₃H, wherein
R² is selected from the group consisting of Cl, Br and OR³, wherein
R³ is selected from the group consisting of H, C₁-C₁₀-alkyl, C₃-C₁₀ cycloalkyl and C₂-C₁₅-alkenyl,
wherein the C₆-C₂₀-arylene can be optionally interrupted by oxygen, sulfur, —NR—, —SO—, or —SO₂—and can be substituted by —COOH or —SO₃H, or a mixture of such groups;
Z is a group of formula (IV) 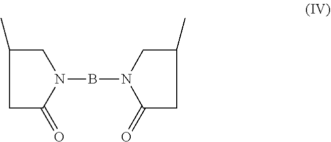
in which B is C₁-C₂₀-alkanediyl, which can be optionally interrupted by one or more non-adjacent oxygen atoms, sulfur atoms or functional groups —NR— where the nitrogen atom can be optionally protonated or quaternized, —CO—, —CO—O—, —CO—NR—, —SO— or —SO₂—, and can optionally carry additional functional groups —COOH or —SO₃H, C₆-C₂₀-cycloalkanediyl or a mixture of such groups
or a mixture of the group of formula (IV) with groups A.

24. The powder paint according to claim 23, comprising
a) 8 to 20 wt.-% of at least one pigment;
b) 10 to 19 wt.-% of at least one re-dispersible dispersion powder (RDP) comprising
i) at least one (co)polymer selected from the group consisting of acrylic acid ester polymer and acrylic-styrene copolymer, and
ii) at least one pyrrolidone-based (co)polymer;
c) 55 to 78 wt.-% of at least one filler;
d) 0.2 to 2 wt.-% of at least one dispersing agent;
e) 0.5 to 2 wt.-% of at least one thickener; and
f) 0.5 to 2 wt.-% of at least one defoamer,
each based on the total dry weight of the powder paint.

25. The powder paint according to claim 23, comprising
a) 21 to 30 wt.-% of at least one pigment;
b) 15 to 25 wt.-% of at least one re-dispersible dispersion powder (RDP) comprising
i) at least one (co)polymer selected from the group consisting of acrylic acid ester polymer and acrylic-styrene copolymer, and
ii) at least one pyrrolidone-based (co)polymer;
c) 40 to 54 wt.-% of at least one filler;
d) 0.2 to 2 wt.-% of at least one dispersing agent;
e) 0.5 to 2 wt.-% of at least one thickener; and
f) 0.5 to 2 wt.-% of at least one defoamer,
each based on the total dry weight of the powder paint.

26. The powder paint according to claim 23, wherein the pyrrolidone-containing polymer (PP) is formed by polymerization of a reactive mixture (rM1), wherein the reactive mixture (rM1) comprises:
(A) at least one itaconic acid derivative, and
(B) at least one diamine.

27. The powder paint according to claim 23, wherein the pyrrolidone-containing polymer (PP) is formed by polymerization of a reactive mixture (rM2), wherein the reactive mixture (rM2) comprises:
(A) at least one itaconic acid derivative, and
(B) at least one amino acid of the general formula (1) 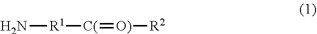
wherein
R¹ is selected from the group consisting of at least monosubstituted C₂-C₂₀-alkanediyl and at least monosubstituted C₃-C₂₀-cycloalkanediyl, wherein the substituent is NH₂;
R² is selected from the group consisting of Cl, Br and OR³, wherein
R³ is selected from the group consisting of H, C₁-C₁₀-alkyl, C₃-C₁₀-cycloalkyl and C₂-C₁₅-alkenyl.

28. The powder paint according to claim 23, wherein the at least one pigment is an inorganic pigment or an organic pigment.

29. The powder paint according to claim 23, wherein the at least one filler is selected from the group consisting of calcium carbonate, precipitated calcium carbonate, talc, mica, silica, alumina silicate, nepheline syenite, clay, calcinated clay, feldspat, and mixtures thereof.

30. A process of manufacturing a paint, the process comprising mixing the powder paint according to claim 23 with water.
